(19) United States
(12) Patent Application Publication
(10) Pub. No.: US 2025/0276753 A1
(43) Pub. Date: Sep. 4, 2025

(54) CARGO PACK FOR MOUNTING ON A BICYCLE

(71) Applicant: Tailfin Limited, Bristol (GB)

(72) Inventors: Nicholas BROADBENT, North Somerset (GB); Robert PHILLIPS, Bristol (GB); Martyn LONG, Bristol (GB)

(21) Appl. No.: 19/062,666

(22) Filed: Feb. 25, 2025

(30) Foreign Application Priority Data
Mar. 1, 2024 (GB) 2403009.0

(51) Int. Cl. B62J 9/21

(52) U.S. Cl. CPC B62J 9/21

(57) ABSTRACT

A cargo pack for mounting on a handlebar 12 of a bicycle comprises a support in the form of a cage 20 which is connected to the handlebar 12 by arms 18. The arms 18 are securely fixed at openings 22 to the handlebar 12 in an adjustable manner, and the cage 20 is connected to the arms 18 by respective connecting structures 38 which enable adjustment of the spacing between the arms 18 in a direction parallel to the axis of the openings 22 and which enable pivoting of the support 20 relatively to 10 the arms 18 about the axis of the openings 22, the connecting structures 38 each having a locking mechanism for locking the support 20 with respect to the arms 18 in a selected pivoted position.

This invention relates to a cargo pack, and is particularly, although not exclusively, concerned with a cargo pack to be mounted on a bicycle, for example on the bicycle handlebars.

Bikepacking is a popular leisure pursuit which often involves multi-day touring on a bicycle, often an off-road bicycle such as a mountain bike. Everything needed for touring is carried on the bicycle or by the rider. There is therefore a need for luggage containers, often referred to as cargo packs, which can be attached to the bicycle and can be loaded with equipment such as clothing, sleeping bags and food.

“Soft” packs, such as collapsible bags, are known for this purpose, but pose particular problems. Different bicycles have widely different configurations, and in particular bicycle handlebars can vary considerably. Cargo packs intended for mounting on bicycle handlebars consequently need to be versatile in order to fit different bicycles.

When such packs are mounted on the bicycle handlebars, it is important for them to be kept away from the front wheel to avoid abrasion and the accompanying buzzing noise. The packs must also be kept away from control elements such as brake levers, gear change controls, trip computers, etc. Also, it is desirable for the packs to be centralised on the handlebars to avoid imbalance. These requirements can be difficult to achieve if the contents of the pack may vary in volume, for example if an item of clothing is taken out of, or placed in, the pack.

According to one aspect of the present invention there is provided a cargo pack carrier for mounting on a handlebar of a bicycle, the carrier comprising a support for receiving a cargo pack, and a pair of arms each attached at one end to the support and having at their other ends aligned openings for receiving the handlebar, the arms being connected to the support by respective connecting structures which enable adjustment of the spacing between the arms in a direction parallel to the axis of the openings and which enable pivoting of the support relatively to the arms about an axis parallel to the axis of the openings, the connecting structures each having a locking mechanism for locking the support with respect to the arms in a selected pivoted position.

Each connecting structure may comprise a fastener which engages a respective slot in the support. Each connecting structure may comprise a barrel bolt accommodated within a bore provided in the respective arm.

The locking mechanism of each connecting structure may be operable to fix the barrel bolt with respect to the bore. The locking mechanism may comprise the fastener of the connecting structure.

The support may have a central spine and lateral rails which are spaced from the spine. The arms may be secured to the spine.

The rails may have slots for receiving retaining straps.

The support may be provided with a support for an accessory.

In accordance with a second aspect of the present invention, there is provided a cargo pack for attachment to a bicycle handlebar, the pack comprising a cargo pack carrier as defined above and a cargo container secured to the support.

The cargo container may be secured to the support by straps. Where the support is provided with slots, the straps may be accommodated in the slots. The straps may extend around the container.

The container may be a bag.

The container may be provided with at least one hook for engagement with the support.

Another aspect of the present invention provides a cargo pack for attachment to a bicycle handlebar, the pack comprising a cargo container and a cargo pack carrier having a support to which the container is secured by at least one releasable retaining device, the container being provided with at least one hook which engages the support to support the container on the support independently of the retaining device.

The hook may be secured to the container by welding. The hook is made from thermoplastics material and the container is made from thermoplastics sheet material.

For a better understanding of the present invention, and to show more clearly how it may be carried into effect, reference will now be made, by way of example, to the accompanying drawings, in which:

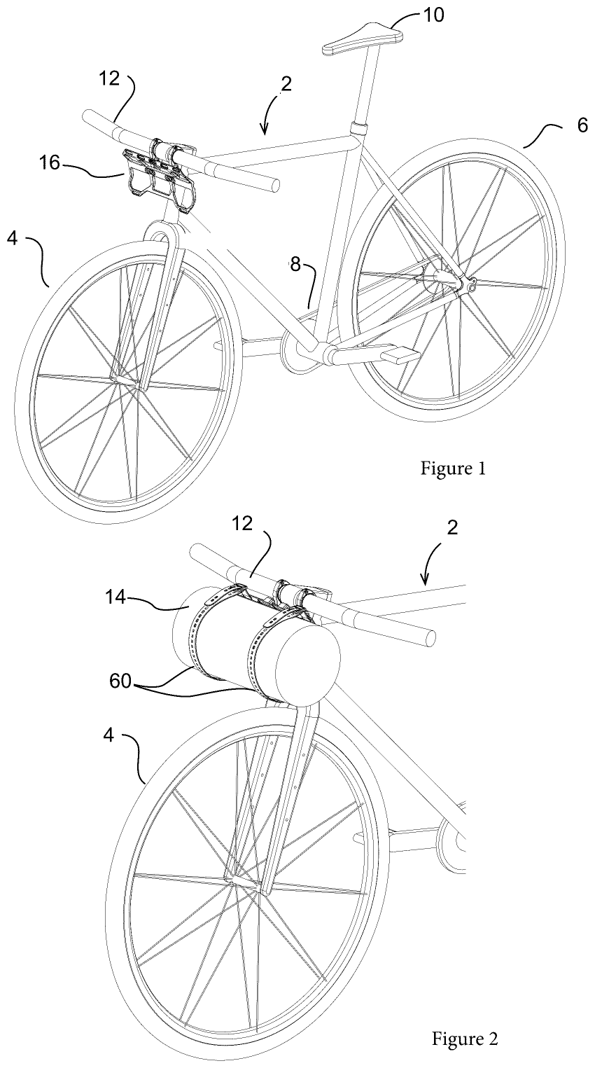

FIG. 1 shows a bicycle provided with a cargo pack carrier;

FIG. 2 is a partial view corresponding to FIG. 1, showing a cargo container fitted to the cargo pack carrier;

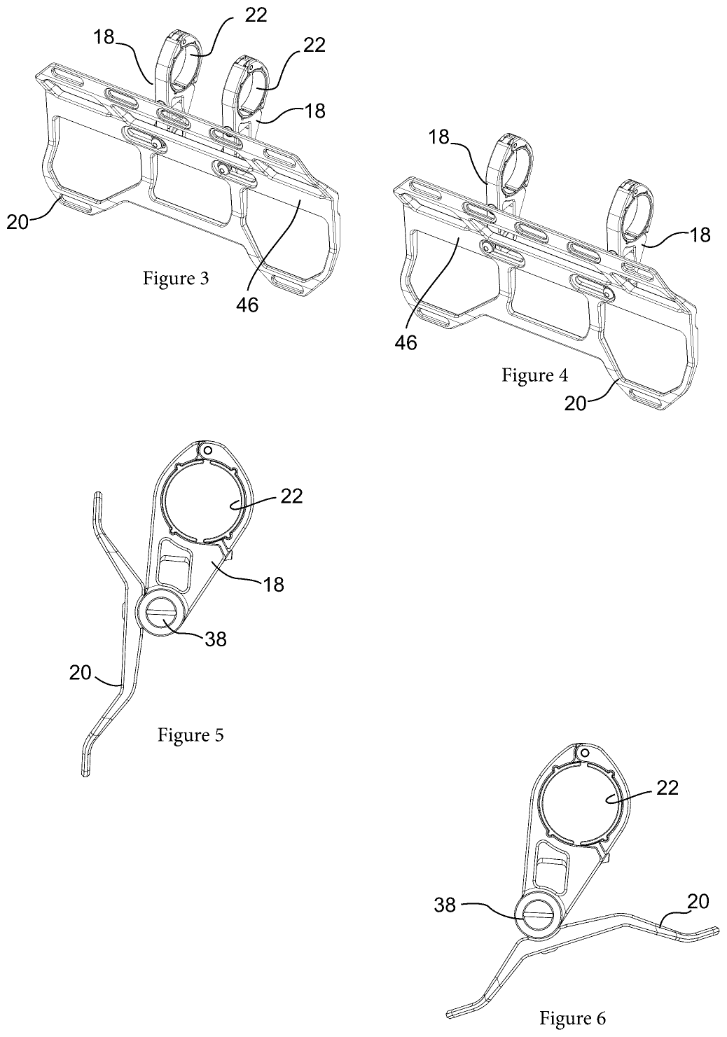

FIG. 3 shows the cargo pack carrier detached from the bicycle;

FIG. 4 corresponds to FIG. 3 but shows the cargo pack carrier in a different configuration;

FIG. 5 is a side view of the cargo pack carrier;

FIG. 6 corresponds to FIG. 5 but shows the cargo pack carrier in a different configuration;

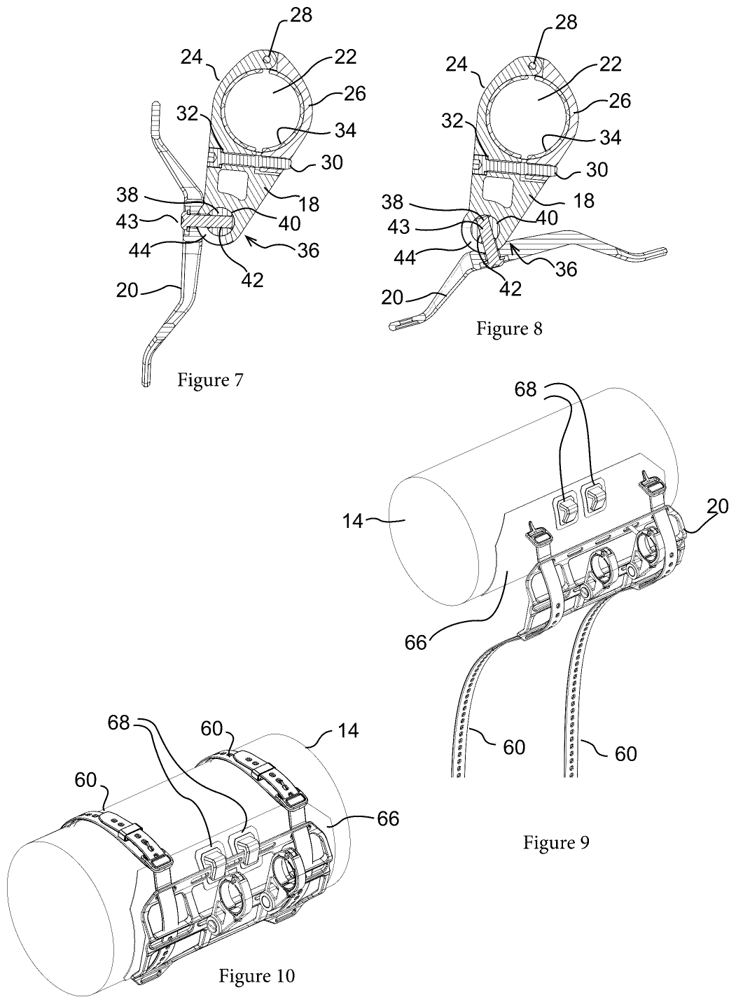

FIG. 7 is a sectional view corresponding to FIG. 5;

FIG. 8 is a sectional view corresponding to FIG. 6

FIG. 9 shows an initial stage in the mounting of the cargo container on the cargo pack carrier;

FIG. 10 corresponds to FIG. 9 but shows a final stage in the mounting of the cargo container; and

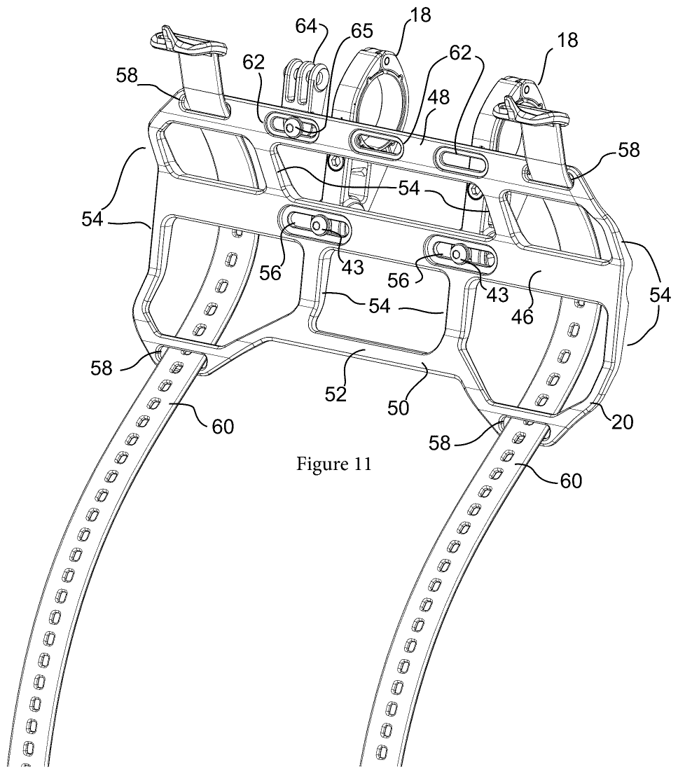

FIG. 11 shows the cargo pack carrier fitted with retaining straps and an accessory mounting attachment.

The bicycle shown in diagrammatic form in FIGS. 1 and 2 comprises a frame 2, front and rear wheels 4 and 6, a chain drive 8, a saddle 10 and a handlebar 12 controlling the front wheel 4. The frame 2 includes a head tube 3 which supports the front wheel 4.

The handlebar 12 comprises a tubular member having a circular cylindrical profile, although it will be appreciated that other forms of member, and other profiles, could be used. In this specification the expression “handlebar” is used to denote the entire tubular member extending from one handgrip to the other.

A cargo pack in the form of a bag 14 is supported on the handlebars 12 by a cargo pack carrier 16 shown in more detail in FIGS. 3 to 7. The cargo pack carrier comprises a pair of arms 18 and a support in the form of a cage 20 which is supported on the handlebar 12 by the arms 18. For this purpose, each arm 18 has an opening 22 at one end which receives the handlebar 12. As shown in FIGS. 3 and 4, the openings 22 of the two arms 18 are aligned with each other so as to fit on a straight handlebar 12, although it will be appreciated that slight deviations from precise straightness may occur.

As can be appreciated from FIG. 7, each arm 18 has a main portion 24 and a clamping portion 26 which is connected to the main portion 24 at a pivot 28. A clamping screw 30 extends through a bore 32 in the main portion 24 into a tapped hole 34 in the clamping portion 26 to enable the arm 18 to be fitted over the handlebar 12 by swinging the clamping portion 26 outwardly and subsequently securing it by means of the clamping screw 30 to grip the handlebar 12 firmly so as to resist displacement of the arm 18 around or along the handlebar 12. A liner 34, for example of very stiff material such as aluminium, is provided on the internal surface of the opening 22 to enhance the grip between the arm 18 and the handlebar 12 while avoiding damage to the handlebar 12. The liner 34 is in two parts, corresponding to the main portion 24 and the clamping portion 26.

At the end of each arm 18 away from the opening 22, the arm is provided with a connecting structure 36 by which the cage 20 is adjustably fitted to the arm 18. The connecting structure 36 comprises a barrel bolt 38 fitted within a plain bore 40 formed in the main portion 24 of the arm 18. The barrel bolt 38 has a tapped cross-bore 42 which receives a fastener 43. The arm 18 has a circumferential slot 44 which extends part of the way around the bore 40 receiving the fastener 43 when engaged in the tapped cross-bore 42.

The cage 20 is made from any suitable substantially rigid material, such as a metallic alloy or a rigid plastics material. It comprises a central spine 46 and a pair of lateral rails 48, 50. As can be appreciated from FIG. 10, the upper rail 48 is straight, whereas the lower rail 50 is kinked, so as to provide an upward displaced region 52. The central spine 46 is connected to the upper and lower rails 48, 50 by relatively thin connecting sections 54. The cage 20 is thus of a relatively light-weight structure.

As can be appreciated from FIGS. 5 and 6, the cage 20 has a convex shape as viewed looking towards the arm 18 so as to serve as a cradle extending partially around the bag 14. The central spine 46 is provided with a pair of counterbored slots 56 positioned to receive the fasteners 43 engaged with the cross-bores 42 in the barrel bolts 38. It will be appreciated that the slots 56 extend parallel to the common axis of the openings 22 and thus allow for the arms 18 to be fixed to the cage 20 at a variety of positions along the central spine 46, so enabling the spacing between the arms 18 to be selected so as to fit in desired positions on the handlebar 12.

The lateral rails 48, 50 are provided with further slots 58 which, as shown in FIG. 10, can receive retaining elements such as Voile Straps® 60 for securing the bag 14 to the cage 20.

Additional counterbored slots 62 are provided in the upper rail 48 for the attachment of accessories such as GPS navigation aids, lights, cameras or mobile phones, for example by way of mountings 64 which may be secured to the cage 20 by suitable fasteners 65 extending through the slots 62.

FIGS. 8 and 9 show the cargo pack carrier 16 fitted with a cargo pack 14 in the form of a container such as a bag. Although represented diagrammatically as a cylinder, the bag 14 may be made from a flexible material, such as a waterproof textile or sheet material, for example a 420D nylon or other plastics material, which is sufficiently stiff to maintain its shape when unstressed, but which will flex if, for example, baggage items are pressed forcefully into the bag, or if straps or the like are tensioned around the periphery of the bag. The bag 14 has an opening (not shown) for loading or unloading the bag and is also provided with a reinforcing layer 66 of an abrasion-resistant material such as thermoplastic polyurethane (TPU). The layer 66 may, for example, be bonded to the material of the bag 14 by welding.

The bag 14 is also provided with a pair of spaced-apart hooks 68 which may also be made from TPU and secured to the bag 14 by welding. In the embodiment shown in FIGS. 8 and 9, the hooks 68 are shown as secured to the reinforcing layer 66, they may be independently fixed to the material of the bag 14, with the reinforcing layer being disposed at a different position on the back 14, for example in the region of the bag 14 most likely to come into accidental contact with the front wheel 4.

As shown in FIGS. 8 and 9, the hooks 68 are disposed on the bag 14 so that they can be placed over the upper rail 48. Thus, in use, the bag 14 can initially be suspended from the cage 20 by means of the hooks 68. This enables the user to fasten the straps 60, which may require the use of both hands, without at the same time leading to support the bag 14.

For use, the arms 18 are fitted to the cage 20 by the fasteners 43 passed through the slots 56 into the cross-bores 42 in the barrel bolts 38. Initially, the fasteners 43 are not fully tightened, so that the arms 18 can be displaced laterally along the slots 56, and also pivoted with respect to the cage 20 by allowing the barrel bolt 38 to rotate within the bore 40, as permitted by the slot 44.

The arms 18 are then fitted over the handlebar 12 by unscrewing the clamping screws 30 of each arm 18 so that the clamping portion 26 can be swung about the pivot 28 to allow the arm 18 to be placed over the handlebar 12. The clamping portion 26 is then closed and the arm 18 is fastened in a desired position along the handlebar 12 by tightening the clamping screw 30. When the cage 20 as reached it's a desired position, both about the axis of the handlebar 12, and about the axis of the barrel bolts 38, the clamping screws 30 can be fully tightened, as can the fasteners 43 in the cross-bores 42. This fixes the position of the cage 20 with respect to the handlebar 12. By way of example, FIGS. 5 and 6 illustrate two alternative positions for the cage 20. In FIG. 5, the cage 20 holds the bag 14 at a forward facing position with respect to the handlebar 12 whereas FIG. 6 shows the cage 20 in a downwardly facing position. It will be appreciated that the cage 20 can be fixed in any orientation between the two positions shown in FIGS. 5 and 6.

In order to mount the bag 14, it is first fitted onto the cage 20 by placing the hooks 66 over the upper rail 48 of the cage 20, leaving the user's hands free to connect up and tighten the straps 60. The straps 60 are then stretched around the bag 14 and secured by means of buckles.

The structure of the cargo pack carrier 16 thus enables the positioning of the bag 14 suitably on the bicycle with a wide degree of versatility to select the bag position, taking account of its size and contents so as to avoid contact with the front wheel four, and to minimise intrusion into the movement envelope of the rider. Also, the structure of the cage 20, and in particular the slots 62, enable additional accessories to be mounted.

The features of the present invention provide a versatile cargo pack carrier while minimising the component count and the operations required to assemble and fit the cargo pack carrier. Also, the fitting of a bag to the cargo pack carrier is simplified by enabling the bag to be supported on the cage 20 by the hooks 66 while final securing by means of the straps 60 takes place.

1. A cargo pack carrier for mounting on a handlebar of a bicycle, the carrier comprising a support for receiving a cargo pack, and a pair of arms each attached at one end to the support and having at their other ends aligned openings for receiving the handlebar, the arms being connected to the support by respective connecting structures which enable adjustment of the spacing between the arms in a direction parallel to the axis of the openings and which enable pivoting of the support relatively to the arms about an axis parallel to the axis of the openings, the connecting structures each having a locking mechanism for locking the support with respect to the arms in a selected pivoted position.

2. A cargo pack carrier as claimed in claim 1, in which each connecting structure comprises a fastener which engages a respective slot in the support.

3. A cargo pack carrier as claimed in claim 1, in which each connecting structure comprises a barrel bolt accommodated within a bore provided in the respective arm.

4. A cargo pack carrier as claimed in claim 3, in which the locking mechanism of each connecting structure is operable to fix the barrel bolt with respect to the bore.

5. A cargo pack carrier as claimed in claim 2, in which the locking mechanism comprises the fastener of the connecting structure.

6. A cargo pack carrier as claimed in claim 1, in which the support has a central spine and lateral rails which are spaced from the spine.

7. A cargo pack carrier as claimed in claim 6, in which the arms are secured to the spine.

8. A cargo pack carrier as claimed in claim 6, in which the rails have slots for receiving retaining straps.

9. A cargo pack carrier as claimed in claim 1, in which the support is provided with a support for an accessory.

10. A cargo pack for attachment to a bicycle handlebar, the pack comprising:
a cargo pack carrier comprising cargo pack carrier for mounting on a handlebar of a bicycle, the carrier comprising a support for receiving a cargo pack, and a pair of arms each attached at one end to the support and having at their other ends aligned openings for receiving the handlebar, the arms being connected to the support by respective connecting structures which enable adjustment of the spacing between the arms in a direction parallel to the axis of the openings and which enable pivoting of the support relatively to the arms about an axis parallel to the axis of the openings, the connecting structures each having a locking mechanism for locking the support with respect to the arms in a selected pivoted position; and
a cargo container secured to the support.

11. A cargo pack as claimed in claim 10, in which the cargo container is secured to the support by straps.

12. A cargo pack as claimed in claim 11, in which the support of the cargo pack carrier has a central spine and lateral rails which are spaced from the spine, and in which the rails of the cargo pack carrier have slots for receiving retaining straps, and in which the straps are accommodated in the slots.

13. A cargo pack as claimed in claim 12, in which the straps extend around the container.

14. A cargo pack as claimed in claim 10, in which the container is a bag.

15. A cargo pack as claimed in claim 10, in which the container is provided with at least one hook for engagement with the support.

16. A cargo pack as claimed in claim 15, in which the hook is secured to the container by welding.

17. A cargo pack as claimed in claim 16, in which the hook is made from thermoplastics material and the container is made from thermoplastics sheet material.

18. A cargo pack for attachment to a bicycle handlebar, the pack comprising a cargo container and a cargo pack carrier having a support to which the container is secured by at least one releasable retaining device, the container being provided with at least one hook which engages the support to support the container on the support independently of the retaining device.

19. A cargo pack as claimed in claim 18, in which the hook is secured to the container by welding.

20. A cargo pack as claimed in claim 19, in which the hook is made from thermoplastics material and the container is made from thermoplastics sheet material.
